(19) United States
(12) Patent Application Publication
(10) Pub. No.: US 2016/0030275 A1
(43) Pub. Date: Feb. 4, 2016

(54) BLIND-GUIDING POSITIONING SYSTEM FOR MOBILE DEVICE AND METHOD FOR OPERATING THE SAME

(71) Applicant: RICHPLAY INFORMATION CO., LTD., NEW TAIPEI CITY (TW)

(72) Inventors: CHI-HSIN LIANG, NEW TAIPEI CITY (TW); YI-HSIANG CHEN, NEW TAIPEI CITY (TW)

(21) Appl. No.: 14/802,090

(22) Filed: Jul. 17, 2015

(30) Foreign Application Priority Data
Jul. 31, 2014 (TW) 103126307

(51) Int. Cl. A61H 3/06; G01S 19/42

(52) U.S. Cl. CPC A61H 3/061; G01S 19/42

(57) ABSTRACT

The present invention relates to a blind-guiding positioning system for mobile device and the method for operating the same. It helps a blind user to capture the local video using the camera module when he wears a portable electronic accessory such as a pair of wearable glasses or when he is followed by a homecare robot. By using the positioning module, the user's location can be confirmed and tracked. Thereby, the family members, the caring units, the police department, or the fire department at the remote side can master the real-time safety condition of the user. In addition, the user can know his location by using the voice. Hence, the user's ability without other's guidance is improved and his safety during activities is ensured as well.

### FIELD OF THE INVENTION

The present invention relates generally to a positioning system and the method for operating the same, and particularly to a blind-guiding positioning system for mobile device and the method for operating the same. The system is provided for the blind for wearing or installed in a home-care robot. Thereby, a user incapable of judging the environment using his vision can know his location via the voice method. In addition, remote family members, carers, policemen or firemen can master the user's safety real-timely.

### BACKGROUND OF THE INVENTION

For the blind, a well-trained guide dog is absolutely the best partner. Nonetheless, even being trained, a guide dog still can only help the blind move around the familiar area or protect their safety on the way. It cannot guide the blind to an unfamiliar destination.

To reach an unfamiliar destination, a current popular method is to us a global positioning system (GPS). This public and standard positioning technology has been extensively integrated into various portable electronic devices such smartphones. Users can use the electronic map shown on smartphones for looking up the geographical location they are currently situated. Nonetheless, this guiding method is not suitable for the blind. Instead, it is only applicable to the users with normal vision.

Accordingly, it is urged by the market demand to improve the guiding system, so that the blind can benefit from the convenience as well.

The Taiwan Patent Publication Number 200806273 disclosed an electronic blind-guiding device, which provides a blind-guiding function to the blind. The characteristic of the invention is to adopt the voice method to broadcast the location of the user. Besides, the user can input the destination using the natural language. Thereby, the electronic blind-guiding device can guide the direction by voice. On the way of movement, the device can alarm for obstacles on the road continuously and record the video of the surrounding environment. If an accident occurs, the video can be inspected for analyzing the process of the accident. Unfortunately, there exist loopholes of safety for the blind in this design. If the assistance is provided by a carer or a guide dog, the risk factors in the environment can be better reacted and thus avoiding danger. If the guide is completely replied on the guiding system, considering the limitation in the accuracy of a normal guiding system, the weather, or the instability of the system, the blind might be very possibly led to wrong areas or approaching the road sections unfriendly, such as the sections without sidewalks, to the blind. At this moment, if no emergent intervention is introduced, the possibility of accidents will be substantially increased. The post-accident analysis is virtually too late. Accordingly, the technology still needs to be improved.

### SUMMARY

An objective of the present invention is to provide a blind-guiding positioning system for mobile device, which acquires the local video by using the camera module in portable accessories such as electronic glasses. In addition, the location of the blind can be located and tracked by using the positioning module. Remote family members, caring units, policemen or firemen can hence master the user's safety real-timely.

Another objective of the present invention is to provide the operating method for a blind-guiding positioning system for mobile device. A user completes the steps via an APP. The camera module can replace the vision that the user lacks. The user can use the sense of hearing to judge safety. The video is monitored by the remote side. Hence, at the necessary moment, actions can be done for ensuring the blind's safety.

In order to achieve the above objectives, the present invention discloses a blind-guiding positioning system for mobile device and the method for operation the same. The hardware comprises a portable electronic accessory at the near side and a monitoring device at the remote side. The monitoring device receives the messages transmitted by the portable electronic accessory, which comprises a camera module, a transmission module, and a positioning module. The camera module has a camera lens disposed on one end of the portable electronic accessory for acquiring a video of the front side of the portable electronic accessory. The transmission module is disposed in the portable electronic accessory for transmitting the video to the monitoring device. The positioning module is disposed in the portable electronic accessory. It acquires a piece of location information of the portable electronic accessory and transmits the location information to the monitoring device via the transmission module.

### BRIEF DESCRIPTION OF THE DRAWINGS

FIG. 1 shows a schematic diagram of spatial relationship according to a preferred embodiment of the present invention for representing the user at the near side and the observer at the remote side;

FIG. 2 shows a schematic diagram of the device architecture according to a preferred embodiment of the present invention for expressing the mechanism in the normal usage;

FIG. 3 shows a schematic diagram of the device architecture according to a preferred embodiment of the present invention for expressing the mechanism in the alarm condition;

FIG. 4 shows a schematic diagram of the device architecture according to a preferred embodiment of the present invention for expressing automatic analysis on the video using the algorithm module; and

FIG. 5 shows a flowchart of operation according to a preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

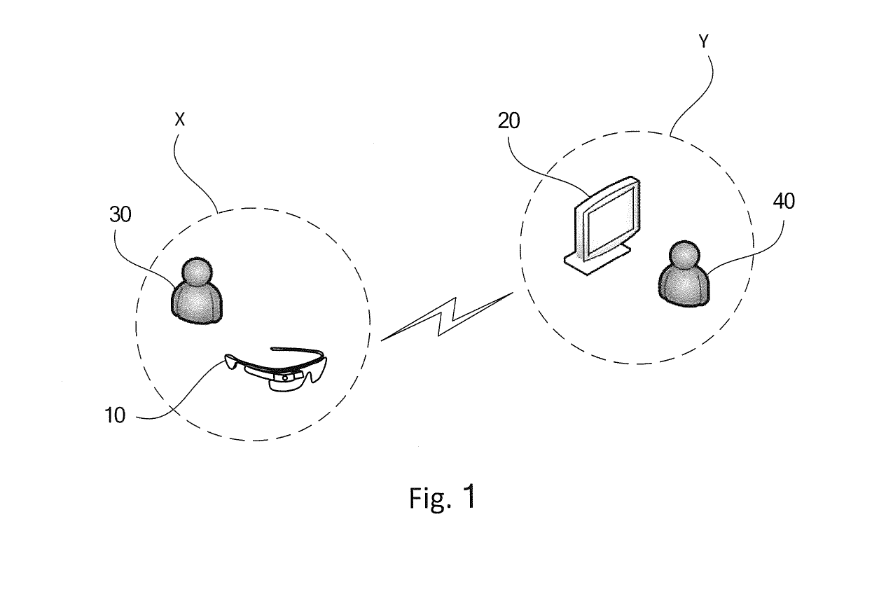

First, please refer to FIG. 1. In the blind-guiding positioning system for mobile device according to the present invention, the hardware comprises the portable electronic accessory 10 at the near side X and the monitoring device 20 at the remote side Y. The monitoring device 20 receives the messages transmitted by the portable electronic accessory 10. Thereby, the observer 40 at the remote side Y can know the activities of the user 30 at the near side X.

The types of the portable electronic accessory 10 are diverse. Any electronic accessory having the camera and transmission functions are applicable. Nonetheless, considering the angle of shooting, the picture stability, and the compatibility with software execution, electronic glasses, such as the Google Glass by Google, are preferred. In addition to the electronic glasses, the portable electronic accessory 10 can be installed on a homecare robot for operation. By taking advantage of the stability of a homecare robot while moving, pictures more suitable for viewing can be provided. Meanwhile, by utilizing the function that a homecare robot always follows the user 30, it is ensured that the acquired video is taken surrounding the user 30.

The target user of the present invention is the blind, who are unable to know the detailed location and the safety of the location they are situated by visual observation. Accordingly, they need help from surrounding people. Alternatively, they can use traditional blind-guiding media such as guide dogs, or the blind-friendly voice broadcasting service provided at the location. Nonetheless, the above supplements are not as convenient and solid as the one provided by the present invention. The blind only need to carry the portable electronic accessory 10 in the blind-guiding positioning system for mobile device according to the present invention or the portable electronic accessory 10 is installed on a homecare robot for acquiring the blind-guiding service.

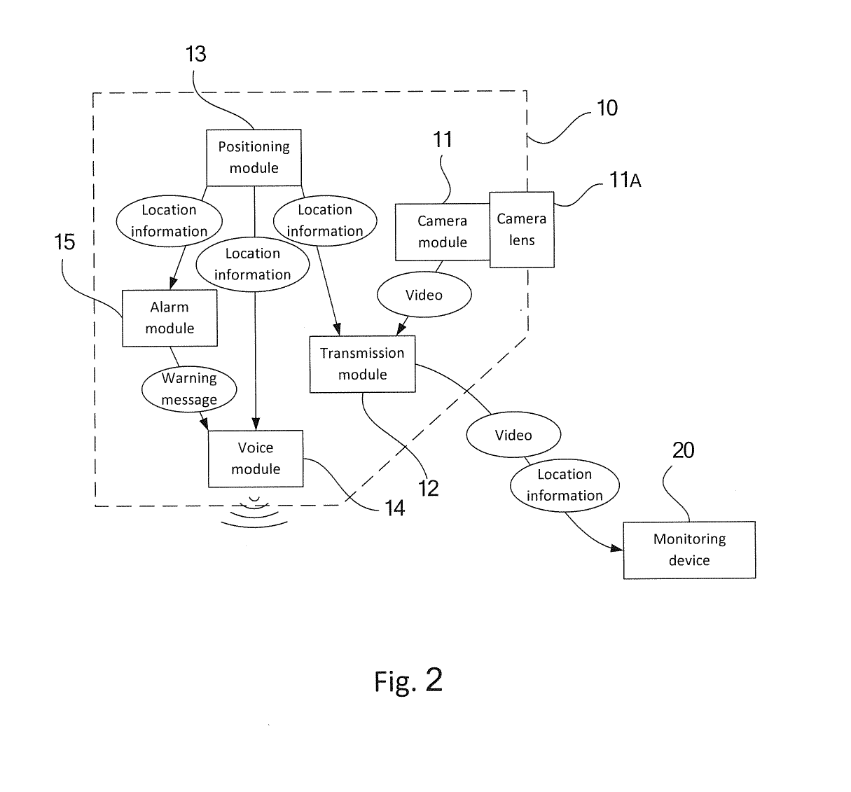

Please refer to FIG. 2. The portable electronic accessory 10 mainly comprises a camera module 11, a transmission module 12, and a positioning module 13. The above modules are disposed in the portable electronic accessory 10 and operate with required processing unit and power supply unit. This part is well known to a person having ordinary skill in the art. The industrial design and product specifications can be planned and adjusted accordingly. Hence, the details will not be described here.

The camera module 11 includes a camera lens 11A disposed on one end of the portable electronic accessory 10 for acquiring a video of the front side of the end of the portable electronic accessory 10. As the above preferred embodiment, when the portable electronic accessory 10 is a Google Glass, because it is worn on a person's head, the video taken by the camera module 11 is the field of vision in front of the user and able to represent the video viewed by the user's eyes.

After the camera module 11 acquires the video, it provides the video to the transmission module 12 for transmission. The video is transmitted to the monitoring device 20 at the remote side, so that the observer at the remote side can inspect the video. Here, the observer includes the user's family members, the caring units, the police department, or the fire department. Generally, for the sake of safety, the user is tracked for making sure the user is situated in a safe environment. The video adopting the user's viewing angle is a quite persuasive observing target. Besides, considering the power load of the portable electronic accessory 10, while transmitting, the video can be extracted as a plurality of images with a fixed time interval for transmission, and thus trading off between observation quality and battery lifetime.

At the moment when the camera module 11 acquires the video, the positioning module 13 will acquire a piece of location information of the portable electronic accessory 10 and transmit the location information to the monitoring device 20 through the transmission module 12. In addition to the popular GPS, the positioning module 13 can acquire the location information using the GLONASS, the BeiDou Navigation Satellite System, or the Galileo positioning system. The positioning module 13 provides the user's location information for the user at the near side and the observer at the remote side. The voice broadcasting method can be adopted, so that the user with visual obstacle still can know his location, the surrounding buildings or stores, the distance to the destination, or the direction to the destination. The observer can also use the location information provided by the positioning module 13 for making sure if the user is in a safe environment or still on the scheduled path. Thereby, when some conditions occur, the user's location can be identified immediately. Then the corresponding actions and processes can be responded.

In order to let the user, as a blind person, know his location and direction, the portable electronic accessory 10 can further comprise a voice module 14, also disposed in the portable electronic accessory 10 and used for broadcasting the location information in the voice method. By listening to the voice, the user can know his location real-timely. Considering that the user is not necessarily located outdoors, the positioning module 13 described above can also work with the data of environmental parameters set additionally, such as the data and local signal transmitters provided by specific buildings including exhibition halls, activity centers, and care centers. Hence, the positioning module 13 can know where the user is located in the plurality of buildings. Then the transmission module 12 can report to the monitoring device 20 at the remote side and the voice module 14 can inform the user at the near side. The voice module 14 contains the required units, such as a speaker, in its structure.

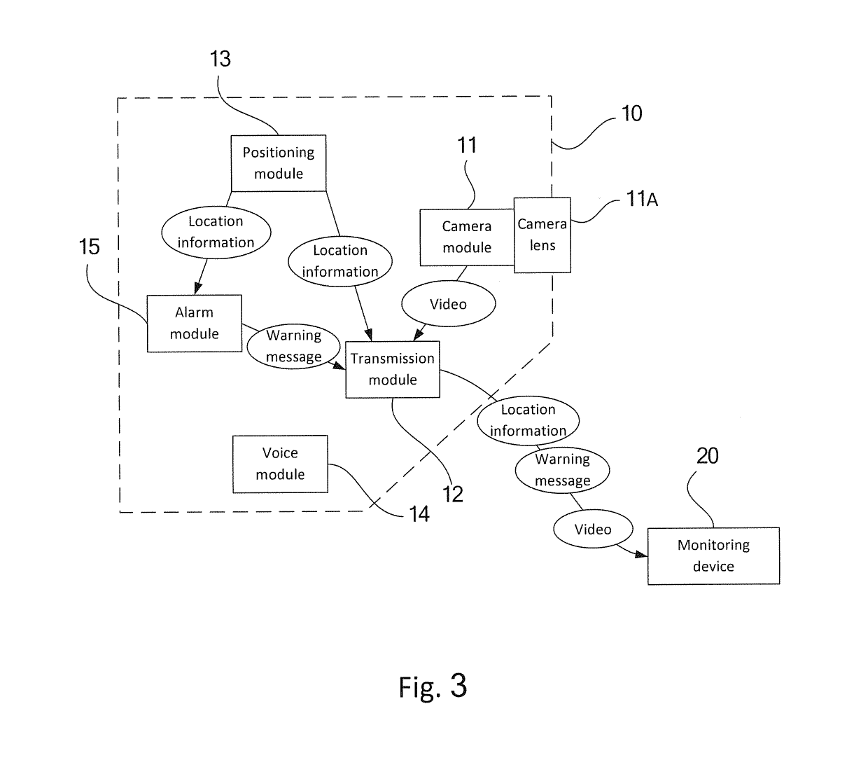

The portable electronic accessory 10 can further comprise an alarm module 15 used for submitting a warning message. This alarm module 15 performs analysis and comparison by referring to the location information of the positioning module 13 for judging if the user's location or moving direction is safe or coincides with the expectation. If necessary, the alarm module 15 will submit the warning message through the voice module 14 for reminding the user that the place he is located is unsafe or that the direction he is moving is different from the one to the destination. Thereby, the user still can know the danger situation or wrong moving direction even he is unable to become aware of the situations spontaneously. Please refer to FIG. 3, in addition to warning the user, the warning message can also be transmitted to the monitoring device 20 at the remote side through the transmission module 11 automatically. Accordingly, the family members, caring units, the police departments, or the fire departments at the remote side can be notified to respond appropriately. Besides, the user can generate the warning message spontaneously. Hence, when an emergence occurs, the blind-guiding positioning system for mobile device according to the present invention can have the function of calling for help as well. No matter the warning message is transmitted automatically or by the user, the system according to the present invention will transmit the location information and the video to the monitoring device 20 altogether. Consequently, the persons at the remote side can know the correct location and situation at the site for further rescue.

The form of the monitoring device 20 as described above is not limited. It can be a smartphone, a tablet computer, a computer, or a screen receiving signals and showing the video. If the monitoring device 20 that the observer uses includes a processing unit, the observer can also use the corresponding application programs, such as an APP operating on a smartphone, for spontaneously selecting connection with the portable electronic accessory 10 and starting the monitoring mode. Moreover, a single monitoring device 20 can also be connected with multiple portable electronic accessories 10 for observing the moving condition and safety of a plurality of blind people.

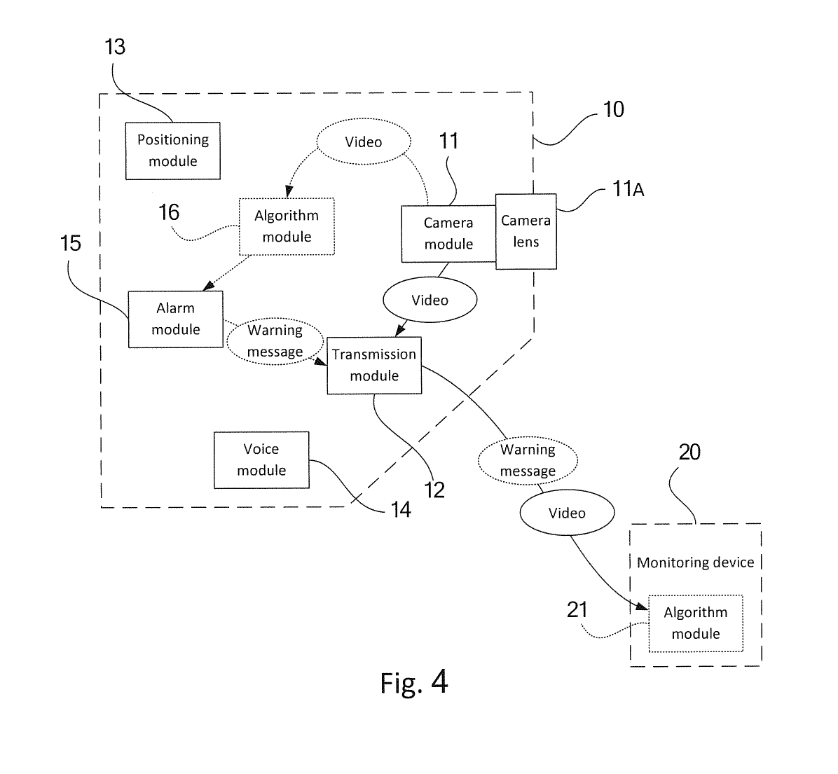

Considering that an observer is not possible to pay close attention to the user's activity conditions, as shown in FIG. 4, the observer can use the algorithm module 16, 21 in the monitoring device 20 or the portable electronic accessory 10 to perform comparison and analysis of the pictures automatically. Because video comparison, namely, 30 to 60 pictures per second, requires higher operating power, the algorithm module in the monitoring device 20 is preferred. This prevents excessive power consumption in the portable electronic accessory 10. The dotted-line path in the figure shows analysis and comparison done by the algorithm module 16 in the portable electronic accessory 10. According to the present preferred embodiment, the video taken by the camera module 11 is transmitted to the algorithm module 21 in the monitoring module 20 through the transmission module 12 for analysis and comparison. After comparison, if a reminder is required, the function of the monitoring device 20 can be used for submitted sound or light. Alternatively, a reminding message can be further transmitted back to the portable electronic accessory 10. Both the observer and the user can receive the automatic analysis result and thus acquiring the supplement or the warning message relevant to safety.

Likewise, an APP can be installed in the portable electronic accessory 10 in the same way. The user can install the APP in the storage space of the portable electronic accessory 10 under the help of other people, such as the carer, and configures the operating schedule and parameters of the camera module 11, the transmission module 12, the positioning module 13, the voice module 14, and the alarm module 15. Thereby, the operation of the portable electronic accessory 10 as worn by the user or installed in a homecare robot can be guaranteed to be effective. In addition, the connection with the monitoring device at the remote side will be stable for transmitting the location information and the video.

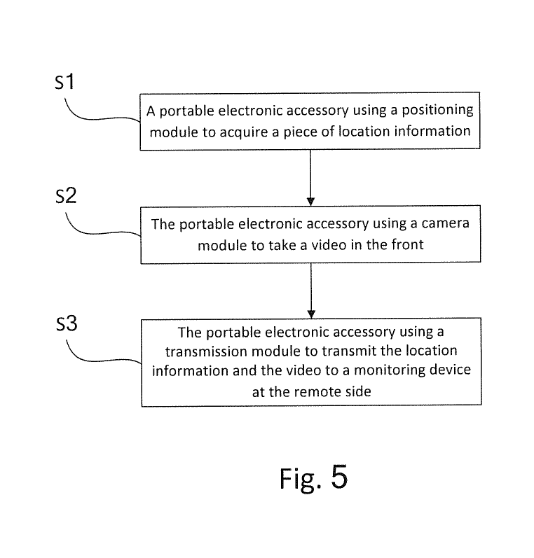

Based on the above hardware architecture, please further refer to FIG. 5, the method for operating the blind-guiding positioning system for mobile device according to the present invention comprises steps of:

Step S1: A portable electronic accessory using a positioning module to acquire a piece of location information;

Step S2: The portable electronic accessory using a camera module to take a video in the front; and

Step S3: The portable electronic accessory using a transmission module to transmit the location information and the video to a monitoring device at the remote side.

The above steps can be executed automatically using the APP. The video quality, the transmission quality, whether to extract the video into images before transmission or not, and the destination of transmission can be configured. After the step of the portable electronic accessory acquiring the location information, and further steps can be included, in which the portable electronic accessory uses a voice module to broadcast the location information in voice. The purpose of this mechanism has been disclosed above. Hence, the details will not be repeated.

To sum up, the present invention discloses in detail a blind-guiding positioning system for mobile device and the method for operating the same. It helps a blind user to capture the local video using the camera module when he wears a portable electronic accessory such as a pair of wearable glasses or when he is followed by a homecare robot. By using the positioning module, the user's location can be confirmed and tracked. Thereby, the family members, the caring units, the police department, or the fire department at the remote side can master the real-time safety condition of the user. In addition, the user can know his location by using the voice. Hence, the user's ability without other's guidance is improved and his safety during activities is ensured as well. Given the convenience, reliability, and diversified functionality, the present invention is undoubtedly an economical and practical blind-guiding positioning system and the method for operating the same.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A blind-guiding positioning system for mobile device, comprising a portable electronic accessory at the near side and a monitoring device at the remote side, said monitoring device receiving the messages transmitted by said portable electronic accessory, and said portable electronic accessory comprising:
a camera module, having a camera lens disposed on one end of said portable electronic accessory for acquiring a video in the front of said portable electronic accessory;
a transmission module, disposed in said portable electronic accessory for transmitting said video to said monitoring device; and
a positioning module, disposed in said portable electronic accessory, acquiring a piece of location information of said portable electronic accessory, and transmitting said location information to said monitoring device through said transmission module.

2. The blind-guiding positioning system for mobile device of claim 1, wherein said portable electronic accessory further comprises a voice module, disposed in said portable electronic accessory for broadcasting said location information in voice.

3. The blind-guiding positioning system for mobile device of claim 1, wherein said portable electronic accessory is a pair of electronic glasses.

4. The blind-guiding positioning system for mobile device of claim 1, wherein said portable electronic accessory is installed in a homecare robot.

5. The blind-guiding positioning system for mobile device of claim 1, wherein said portable electronic accessory further comprises an alarm module for submitting a warning message.

6. The blind-guiding positioning system for mobile device of claim 5, wherein said warning message is broadcasted via a voice module and transmitted to said monitoring device through said transmission module concurrently.

7. The blind-guiding positioning system for mobile device of claim 1, wherein said monitoring device is a smartphone, a tablet computer, a computer, or a screen.

8. The blind-guiding positioning system for mobile device of claim 1, wherein said positioning module adopts the GPS, the GLONASS, the BeiDou Navigation Satellite System, or the Galileo positioning system for acquiring said location information.

9. The blind-guiding positioning system for mobile device of claim 1, wherein said electronic accessory further comprises an algorithm module for receiving said video of said camera module for analysis, and an alarm module of said portable electronic accessory submits a warning message according to the analysis result.

10. The blind-guiding positioning system for mobile device of claim 1, wherein said monitoring device further comprises an algorithm module for receiving said video transmitted by said camera module through said transmission module for analysis, and said monitoring device submits a warning message according to the analysis result.

11. A method for operating a blind-guiding positioning system for mobile device, comprising steps of:
a portable electronic accessory using a positioning module to acquire a piece of location information;
said portable electronic accessory using a camera module to take a video in the front; and
said portable electronic accessory using a transmission module to transmit said location information and said video to a monitoring device at the remote side.

12. The method for operating a blind-guiding positioning system for mobile device of claim 11, and after said step of said portable electronic accessory acquiring said location information, further comprising a step of said portable electronic accessory using a voice module to broadcast said location information in voice.
